(19) United States
(12) Patent Application Publication
(10) Pub. No.: US 2004/0246670 A1
(43) Pub. Date: Dec. 9, 2004

(54) Portable computer

(75) Inventor: Tzu-Wei Lai, Taipei City (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/799,678

(22) Filed: Mar. 15, 2004

(30) Foreign Application Priority Data
Jun. 9, 2003 (TW) 092210457

(51) Int. Cl. G06F 1/16

(52) U.S. Cl. 361/683; 361/686

(57) ABSTRACT

A portable computer includes a base, the base having a top face, a bottom face, a front edge, a rear edge, two opposite side edges, and a keyboard in the top face, a display unit, the display unit having a display screen for showing data, a top side, a bottom side, and two opposite lateral sides, and two coupling arms coupling the display unit to the base, the coupling arms each having a first end pivotally coupled to one lateral side of the display unit near the bottom side of the display unit, a second end pivotally coupled to a middle part of one side edge of the base, and an internal space for the passing of the electric signal line, which is electrically connected between the base and the display unit.

### BACKGROUND OF THE INVENTION

1. Field of the Invention

The present invention relates to a portable computer and, more particularly, to such a portable computer that allows the user to adjust the view angle of the display screen.

2. Description of Related Art

Due to the slowing growth rate of the desktop computer market and the saturated notebook computer market situation, computer suppliers have been continuously trying to develop different styles of new designs of computers to attract consumers.

A regular notebook computer is comprised of a base and a display. The display is pivotally coupled to the rear side of the base. This design facilitates closing/opening and portability. However, due to one specific display orientation, a notebook computer does not provide multiple viewing angles.

U.S. Pat. Nos. 6,266,236 and 6,005,767 provide apparatuses and methods for connecting and articulating displays in portable computers having multiple display orientations. According to the design common to these patents, the computer comprises a base, which has a top face, a bottom face, two side edges, a rear edge, and a front edge, a display unit, which has a top face, a bottom face, and two side edges, and an arm assembly coupling the display unit to the base. The arm assembly has two arm portions. Each arm portion has a first end pivotally coupled to one side edge of the base near the rear edge, and a second end pivotally coupled to the mid point of one side edge of the display unit. According to this design, the display unit is not directly coupled to the base of the computer; therefore it is rotatable through 360°. By means of the arm assembly, the user can adjust the standing angle of the display unit, enabling it to be retained in a selected one of a plurality of different positions. Moreover, the user can have the display screen face a person sitting on the opposing side without turning the base.

However, this assembly still has limitations. One drawback of this design of portable computer is that the installation of the pivots in the side edges of the base near the rear edge for the connection of the arm assembly to the base limits the arrangement of an expansion slot (for example, USB, VGA-out) at the rear edge of the base. Another drawback of this design of portable computer is that the keyboard must be set close to the front edge of the base, and thus no spaces are left around the front side for receiving a palm rest and a cursor control device (touch pad or track point).

Therefore, it is desirable to provide a portable computer that eliminates the aforesaid drawbacks.

### SUMMARY OF THE INVENTION

It is the main object of the present invention to provide a portable computer, which enhances the expandability of the rear edge of the base.

It is another object of the present invention to provide a portable computer, which allows installation of a palm rest and a cursor control device in the top face of the base.

To achieve these and other objects of the present invention, the portable computer comprises a base, the base having a top face, a bottom face, a front edge, a rear edge, two opposite side edges, and a keyboard in the top face, a display unit, the display unit having a display screen for showing data, a top side, a bottom side, and two opposite lateral sides, and two coupling arms coupling the display unit to the base, the coupling arms each having a first end pivotally coupled to one lateral side of the display unit near the bottom side of said display unit, a second end pivotally coupled to a middle part of one side edge of the base, and an internal space for the passing of the electric signal line, which is electrically connected between the base and the display unit.

In short, the invention has one end of each of the two coupling arms coupled to a middle part of one side edge of the base and the other end of each of the two coupling arms coupled to one lateral side of the display unit near the bottom side. This arrangement allows arrangement of expansion slots wirings in the rear edge of the base and installation of a palm rest and a cursor control device in the top face of the base while maintaining the feature of allowing the display unit to be turned to one of a plurality of viewing angles.

### BRIEF DESCRIPTION OF THE DRAWINGS

FIG. 1 is an oblique rear elevation of the preferred embodiment of the present invention.

FIG. 2 is an oblique front elevation of the preferred embodiment of the present invention.

FIG. 3 illustrates one status of use of the preferred embodiment of the present invention.

### DETAILED DESCRIPTION OF THE PREFERRED EMBODIMENT

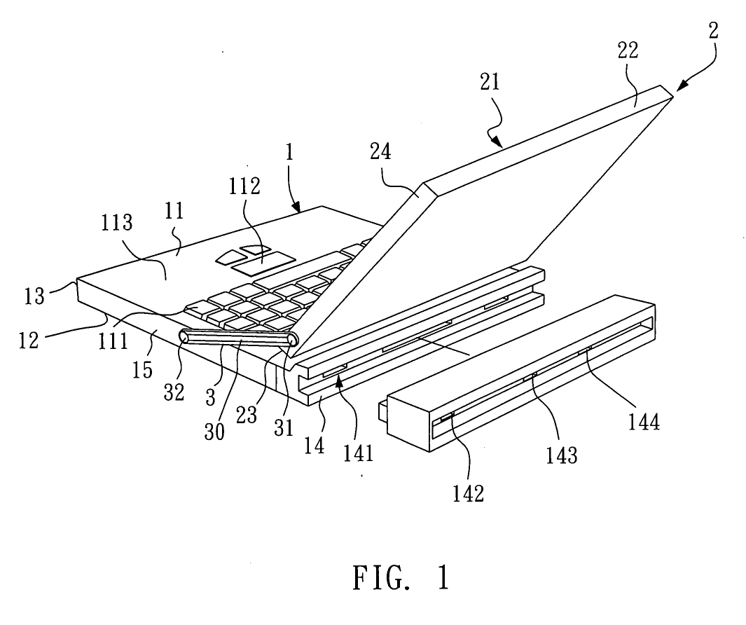

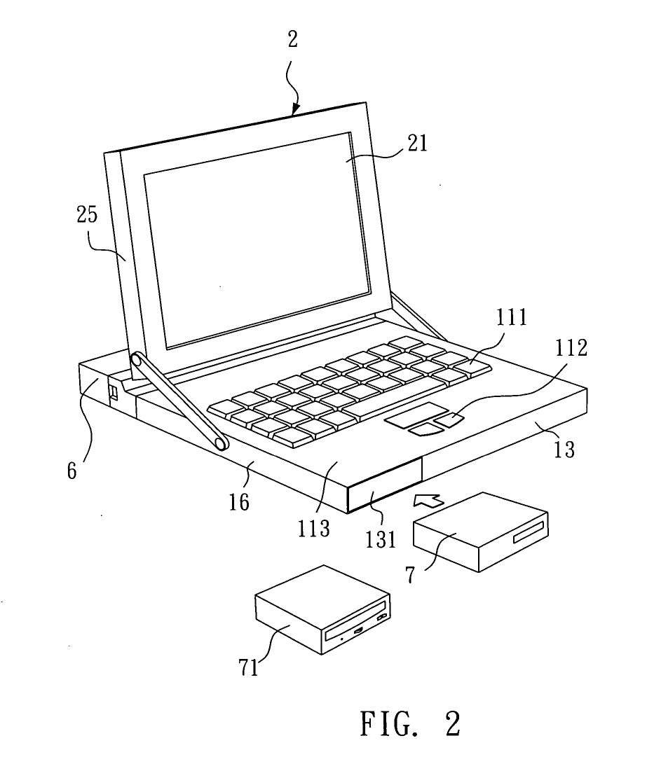

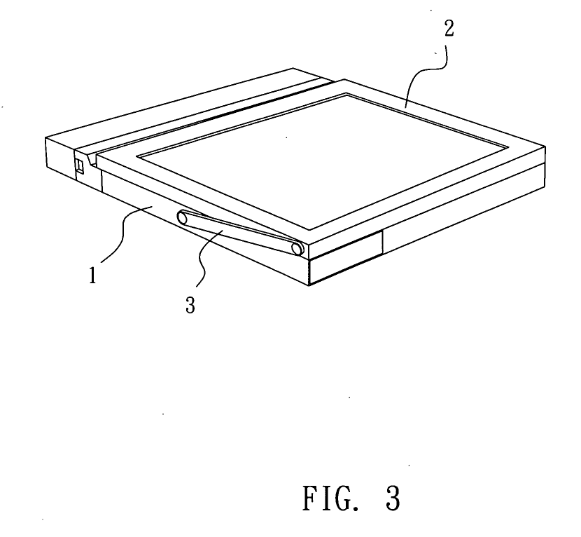

Referring to FIGS. 1 and 2, a portable computer is shown comprising a base 1, and a display unit 2. The base 1 has a top face 11, a bottom face 12, a front edge 13, a rear edge 14, and two opposite side edges 15 and 16. The top face 11 is provided with a keyboard 111. The display unit 2 has a display screen 21 for showing data, a top side 22, a bottom side 23, and two opposite lateral sides 24 and 25. The portable computer further comprises two coupling arms 3 that couple the display unit 2 to the base 1. The coupling arms 3 are elongated members each having a first end 31 pivotally coupled to one lateral side 24 of the display unit 2 near the bottom side 23, and a second end 32 pivotally coupled to a middle part of one side edge 15 of the base 1. The coupling arms 3 are hollow members adapted to accommodate an electric signal line 30, which electrically connects the display unit 2 to the base 1 through an internal circuit. By means of the coupling arms 3, the display unit 2 can be closed on the top face 11 of the base 1 as shown in FIG. 3, or standing on the base 1 in one of a plurality of different angular positions.

The coupling arms 3 may be coupled to the base 1 and the display unit 2 in any of a variety of known methods. The connection between each coupling arm 3 and the base 1 or display unit 2 can be a stepless connection, multi-step connection, friction connection, or any of a variety of connections that allow the user to adjust the display unit 2 subject to the desired viewing angle and to have the display unit 2 retained in the adjusted position.

As stated before, the main object of the present invention is to provide a portable computer, which allows installation of a palm rest and a cursor control device in the top face of the base. As shown in the drawings, an expansion battery pack 6 is attached to the rear side of the base 1. Because the arm assembly of the prior art design must be coupled to the side edges of the base of the computer near the rear edge of the base, the positioning of the pivots does not allow installation of an expansion connection in the rear edge of the base. The present invention eliminates this problem by coupling the coupling arms 3 to a middle part of each side edge 15,16 of the base 1. Therefore, multiple expansion connectors 141 can be installed in the rear edge 14 of the base 1 for receiving, for example, the expansion battery pack 6 to extend the work time of the computer, or the expansion connectors 142,143,144 of a port replicator. Alternatively, peripheral apparatus may be directly connected to the expansion connectors 141. These expansion connectors (either the connectors at the port replicator or the connectors at the base) can be, but not limited to, the combination of IEEE-1394 slots, USB slots, CD-ROM signal slots, communication port slots, parallel port slots, network signal slots, modem signal slots, audio signal slots, video output slots, and power jacks.

Referring to FIG. 2, in addition to the keyboard 111, a cursor control device 112 is provided at the top face 11 of the base 1 near the front edge. According to the aforesaid prior art design, the arm assembly must be coupled to the side edges of the base near the rear edge, and the top face of the base has no room to accommodate a palm rest and a cursor control device after the installation of the keyboard. Without the palm rest, the user's arm feels uncomfortable when operating the keys of the keyboard. Without the cursor control device, the user cannot conveniently control the cursor on the display screen of the display unit. The invention eliminates these problems. The coupling arrangement between the coupling arms 3 and the base 1 and display unit 2 allows full utilization of the top face of the base 1, i.e., a cursor control device 112 and a palm rest 113 can be installed in the top face 11 of the base 1 to improve the user's working efficiency and comfortability. According to the present preferred embodiment, the cursor control device 112 is a touch pad. However, a track ball, track point, or any of a variety of equivalent cursor control means may be used as a substitute.

Referring to FIG. 2 again, a mobile-rack slot 131 is provided in the front edge 13 of the base 1 and adapted to accommodate one of a variety of mobile computer peripheral apparatus 7, for example, a mobile CD/DVD player 71, a mobile floppy disk drive. Preferably, the mobile-rack slot 131 is a hot-swap design that allows the user to change the mobile rack during power-on status of the computer.

As indicated above, the invention has the coupling arms coupled between a middle part of each side edge of the base and the lateral sides of the display unit near the bottom side to increase the extensibility and the utilization of the top space of the computer. The invention also provides the base of the computer with a hot-swap mobile-rack slot for convenient use of any of a variety of mobile racks.

Although the present invention has been explained in relation to its preferred embodiment, it is to be understood that many other possible modifications and variations can be made without departing from the spirit and scope of the invention as hereinafter claimed.

What is claimed is:

1. A portable computer comprising:
a base, said base having a top face, a bottom face, a front edge, a rear edge, and two opposite side edges, said top face having a keyboard installed thereon;
a display unit, said display unit having a display screen for showing data, a top side, a bottom side, and two opposite lateral sides; and
two coupling arms coupling said display unit to said base, said coupling arms each having a first end pivotally coupled to one lateral side of said display unit near the bottom side of said display unit, a second end pivotally coupled to a middle part of one side edge of said base, and an internal space for the passing of an electric signal line being electrically connected between said base and said display unit.

2. The portable computer as claimed in claim 1, wherein said base further comprises a cursor control device.

3. The portable computer as claimed in claim 2, wherein said cursor control device is a touch pad.

4. The portable computer as claimed in claim 1, wherein said base further comprises an expansion slot set in the rear edge thereof.

5. The portable computer as claimed in claim 4, wherein said expansion slot is a battery slot holding an expansion battery pack.

6. The portable computer as claimed in claim 4, wherein said expansion slot is a port replicator, said port replicator comprising at least one expansion slot.

7. The portable computer as claimed in claim 1, wherein said base comprises a detachable expansion unit in the front edge thereof.

8. The portable computer as claimed in claim 7, wherein said expansion unit is a CD-ROM player.
